(19) United States
(12) Patent Application Publication
(10) Pub. No.: US 2025/0073649 A1
(43) Pub. Date: Mar. 6, 2025

(54) MONOVALENT SELECTIVE ANION EXCHANGE MEMBRANE FOR APPLICATION IN LITHIUM EXTRACTION FROM NATURAL SOURCES

(71) Applicant: ENERGY EXPLORATION TECHNOLOGIES, INC., Austin, TX (US)

(72) Inventors: George Y. GU, Austin, TX (US); Michael Z. HU, Austin, TX (US); Amit PATWARDHAN, Austin, TX (US); Rachelle LYNDON, Austin, TX (US); Guanyu MA, Austin, TX (US); Teague M. EGAN, Austin, TX (US)

(73) Assignee: ENERGY EXPLORATION TECHNOLOGIES, INC., Austin, TX (US)

(21) Appl. No.: 18/701,313

(22) PCT Filed: Oct. 21, 2022
(86) PCT No.: PCT/US2022/078533

§ 371 Date: Apr. 15, 2024

Related U.S. Application Data
(60) Provisional application No. 63/270,299, filed on Oct. 21, 2021.

(51) Int. Cl. B01D 71/82; B01D 67/00; B01D 71/28

(52) U.S. Cl. CPC B01D 71/82; B01D 67/0006; B01D 71/28; B01D 2323/21834; B01D 2323/30; B01D 2325/42

(57) ABSTRACT

A method of making monovalent and multivalent anion selective membrane. Such membrane can be used for electrodialysis (“ED”) operation and applied towards the important Cl⁻—SO₄²⁻ separation in lithium extraction. The membrane thickness is much less than 100 μm, preferably less than 50 μm, more preferably less than 40 μm, and most preferably 20-30 μm.

This application claims the benefit of priority to U.S. Provisional Application No. 63/270,299, filed on Oct. 21, 2021, the entire contents of which are hereby incorporated by reference.

### BACKGROUND OF THE INVENTION

### 1. Technical Field

The present disclosure generally relates to anion exchange membranes for use in lithium extraction from natural resources. More specifically, the disclosure relates to monovalent and multivalent anion selective membranes for use in electrodialysis (“ED”) during lithium extraction.

### 2. Description of Related Art

Lithium is widely used for many industrial applications including lithium-ion batteries, glasses, greases, and other applications such as metallurgy, pharmaceutical industry, primary aluminum production, organic synthesis, etc. Lithium mining has drawn significant interest due to the recent surge in electrical vehicle (“EV”) market and its increasing forecast. Lithium-ion batteries have so far demonstrated highest energy density and stability for automobile applications. Lithium production is expected to triple between 2021 and 2025 due to the projected growth in EV mobility and grid storage. Most lithium production in past and recent years has been from the so-called lithium triangle comprising the convergence of Chile, Argentina, and Bolivia in South America. Even though the newer production has been coming from hard-rock sources such as spodumene in Western Australia, the dominance of brine-based production is expected to continue into the foreseeable future. In 10-20 years, recycling of lithium from spent batteries is also expected to supplant new production.

Lithium recovery from salt lake brine is a long process that involves drilling in order to access the sub surface brine deposits, pumping brine to the surface, and brine distribution to solar evaporation ponds where the brine is concentrated for 18-24 months. During the solar evaporation stage, sodium, potassium and magnesium chloride salts precipitate before lithium precipitation losses begin. Lithium concentration nevertheless continues to increase sacrificing 40-70% of the contained lithium as a co-precipitate mixed with other less valuable salts. The final concentrated lithium brine is then processed through a series of separation steps involving solvent extraction for boron removal, lime-soda softening for Mg, Ca and heavy metal impurity removal followed by precipitation with soda ash as lithium carbonate. The crude lithium carbonate is further refined to battery grade or converted to a battery grade lithium hydroxide monohydrate product again involving additional processing steps. A majority of the world's lithium carbonate and hydroxide is produced in this fashion.

To prevent the large environmental footprint of solar evaporation ponds, the evaporative loss of water in one of the world's most arid regions, achieve significantly higher lithium recovery from the resource, and utilize lower grade lithium resources, Direct Lithium Extraction (“DLE”) has gained significant interest. DLE involves pumping of the subsurface brine and selective separation of Li from all other impurity cations using selective ion exchange, ion sorption, membrane separation, or solvent extraction and returning the lithium depleted brine to the brine pool. Only one commercial application of a combined DLE and solar evaporation pond approach is in production in Argentina today. Due to the increasing focus on sustainability of lithium extraction “pure” DLE approach is an eventual certainty. In parallel, suitable separations such between Li⁺ and Mg²⁺, and, Cl⁻ and SO²⁻, if applied at the right point in the process, the proven and conventional low recovery solar evaporation process can be enhanced to match the recovery benefits of DLE at a lower cost from existing and even newer operations.

Lithium extraction from ores involves pyrometallurgical and/or hydrometallurgical processes. In the case of lithium salt production from spodumene, lithium concentrate is produced by gravity, heavy media, flotation, and magnetic separation. Afterwards, α-spodumene is converted into β-spodumene at 1070-1090° C. in order to get easier lithium extraction by sulfuric acid at 250° C. The residue is then washed with water at 90° C. in order to dissolve lithium sulfate. Impurities such as iron, aluminum, magnesium, calcium, etc., are removed by precipitation. Crude lithium carbonate is the precipitated with addition of soda ash and further refined to make battery grade products as with the brine based processes. Some ores such as low grade hectorite clays are treated in a similar fashion. Ores such as jadarite require no pyrometallurgical treatment but follow the same hydrometallurgical steps.

### SUMMARY OF THE INVENTION

Presently, the implementation of membrane processes in lithium production flowsheets is very limited and forms part of the newer DLE processes. The applications involve mainly nanofiltration (“NF”) for divalent rejection and reverse osmosis (“RO”) for lithium concentration. The application is limited by the total dissolved solids (“TDS”) content of the brine and majority of lithium, and hence impurity concentration occurs by the use of expensive mechanical thermal evaporation.

Electrodialysis (“ED”) is a membrane process that is not limited by high TDS (>3.5%) as is prevalent in lithium brines. In addition, it facilitates brine concentration simultaneously with impurity ion separation. ED allows ion separation under the influence of an applied electrical current. Under an electrical potential between the anode and the cathode, the positively charged cations migrate towards the cathode and the negatively charged anions move towards the anode. The ED module consists of cation and anion membrane alternately arranged. The cation membranes have anion functional groups such as —SO₃⁻ immobilized that can prohibit anions passing though while anion membranes possess fixed cation groups such as —NR₃⁺ enabling only anions passing though preventing passage of cations.

As described earlier, more than two-thirds of the lithium resources in the world reside in the lithium triangle. These very high salinity brines contain lithium concentrations ranging from 200 ppm-2000 ppm. Lithium in these brines is associated with high levels of Na⁺, K⁺, Mg²⁺, Cl⁻, SO₄²⁻, B (ionic or molecular) and other ions. Every brine chemistry is unique. However, they can be broadly classified into high magnesium and high sulfate brines based on their impurity profile. Nearly 80% of these brines can be classified as high sulfate brines. Most of the world's brine-based lithium production is from the 20% low sulfate brines found in Chile. In all cases, major co-precipitation losses of lithium occur during the evaporation and concentration process. In high magnesium brines, the losses occur mainly as a lithium carnalite precipitate (LiCl·MgCl₂·7H₂O). In high sulfate brines, losses occur mainly as lithium sulfate monohydrate (Li₂SO₄·H₂O) and lithium schoenite (Li₂SO₄·K₂SO₄). Hence, the ability to separate Li⁺ from Mg²⁺ and Cl⁻ from SO₄²⁻ can increase lithium recovery from these resources by 100-300%. A perfect example is the Bolivian lithium resource which accounts for 25% of the global lithium resource and 40% of the global brine-based lithium resource. No production of lithium at commercial scale has been possible so far because of the very high sulfate content of this resource in addition to the high magnesium content and relatively low lithium concentration. Ability to separate SO₄²⁻ from Cl⁻ can make this resource economically viable. The elimination of SO₄²⁻ from Cl⁻ is particularly important and it forms some embodiments of this invention disclosure.

Very few separation technologies can successfully operate in these conditions and high salinity exceeding 3.5% TDS. Of those that can, even fewer technologies can separate SO₄²⁻ from Cl⁻. Selective Membrane Electrodialysis (“SME”), particularly using the selective anion exchange membrane described in this invention, can accomplish this separation to unlock some of the biggest lithium resources in the world.

Accordingly, one embodiment is a method where a monovalent selective ion exchange membrane has been applied to ED separation such as sea salt harvest and irrigation water desalting. In monovalent selective cation exchange membrane (“sCEM”) most membrane products are enabled by modifying the surface with same charge moieties to provide coulombic energy barrier. In monovalent selective anion exchange membrane (“sAEM”) however, the modification to the bulk ammonium moieties is more efficient.

Another embodiment is a method to modify the alkyl of the ammonium group of the anion exchange membrane (“AEM”) to varying degrees of hydrophobicity by using trimethylamine N(CH₃)₃ (TMA), triethylamine N(CH₂CH₃)₃ (TEA), tri-n-propylamine N(CH₂CH₂CH₃)₃ (TPrA), tri-n-butylamine N(CH₂CH₂CH₂CH₃)₃ (TBA) and tri-n-pentylamine N(CH₂CH₂CH₂CH₂CH₃)₃ (TPA) groups. In some aspects, the present invention may relate to the one or more tertiary amines that have been attached to the membrane as quaternary ammonium salts. These groups on these amines may be one or more alkyl groups. These alkyl groups may have from 1 to 8 carbon atoms each or from 2 to 6 carbon atoms each. The substrate AEM precursor film is the copolymer of vinylbenzylchloride (“VBC”) and divinylbenzene (“DVB”). The membrane may have a thickness of at least 100 μm. The amination reactivity (and the formed AEM conductivity) for trialkylamine follows the order of: TMA>TEA>TPrA>TBA>TPA.

The amination reaction for long alkyl chain is very slow or in many cases cannot react thoroughly inside the bulk of the membrane. This may result in a final AEM areal resistivity approaching >100 Ω-cm² making it less desirable for application in ED. To improve this method, it is very important to develop a precursor film with a thickness much less than 100 μm, preferably less than 50 μm, more preferably less than or close to 40 μm and most preferably 20-30 μm to facilitate a through amination to the bulk within a reasonable reaction time and acceptable resistivity. In some aspects, the precursor film may have a thickness less than 100 μm, 90 μm, 80 μm, 70 μm, 60 μm, 50 μm, 40 μm, or 30 μm. The thickness of the precursor film may be from about 5 μm to about 100 μm, from about 10 μm to about 50 μm, or from about 20 μm to about 30 μm.

In some aspects, these membranes are used to separate lithium in a solution wherein the solution has a total dissolved solid concentration of at least 0.5%, of at least 3%, or at least 10%. In some aspects, the total dissolved solid concentration is from about 0.5% to about 75%, from about 1% to about 70%, or from about 10% to about 60%. The total dissolved solid concentration is from about 0.5%, 1%, 2%, 3%, 4%, 5%, 6%, 7%, 8%, 9%, 10%, 12.5%, 15%, 20%, 25%, 30%, 35%, 40%, 50%, 60%, 70%, to about 75%, or any range derivable therein. The presently disclosed membranes may have a relative transport number of at least 3. The relative transport number or RTN measures the selectivity for certain anions in the membrane relative another anion. The membranes may have a relative transport number of greater than 3, 5, 10, 20, 25, or 50. In some embodiments, the relative transport number is from about 3 to about 2,000, from about 50 to about 1,000 or from about 120 to about 500.

In some aspects, the present disclosure provides methods of separating monovalent anions from one or more multivalent anions in a lithium salt solution comprising:
(A) exposing an anion exchange membrane, wherein the anion exchange membrane is a polyvinyl membrane containing one or more quaternary ammonium cations; and
(B) allowing the anions in the lithium salt solution to pass through the anion exchange membrane such that monovalent anions are on one side of the anion exchange membrane and multivalent anions are on the other side of the anion exchange membrane.

In some embodiments, the quaternary ammonium cation comprises at least three alkyl chains on the amine that are not tethered to the polymer chain. In some embodiments, the alkyl chains are each from about 1 carbon atoms to about 12 carbon atoms. In some embodiments, the alkyl chains are from about 3 carbon atoms to about 8 carbon atoms. In some embodiments, the alkyl chains are each 4 carbon atoms. In some embodiments, the 3 alkyl moieties are any covalently bonded atoms or other compound groups to acquire the membrane with said selectivity in 1(B). In some embodiments, the anion exchange membrane is crosslinked with a divinyl compound. In some embodiments, the divinyl compound is a divinylaryl compound. In some embodiments, the divinyl compound is divinylbenzene. In some embodiments, the polyvinyl is a vinylbenzene.

In some embodiments, the anion exchange membrane is prepared by saturating a substrate with the monomer containing thermal or UV initiator and polymerized subsequently. In some embodiments, the substrate is a polymer or ceramic. In some embodiments, the substrate is porous material. In some embodiments, the monovalent anion is a halide, NO₃⁻ or another compound anion. In some embodiments, the compound anion is a carboxylic acid. In some embodiments, the compound anion is acetate (CH₃C(O)O⁻). In some embodiments, the monovalent anion is a halide. In some embodiments, the halide is Br⁻ or Cl⁻. In some embodiments, the halide is Cl⁻. In some embodiments, the multivalent anion is SO₄²⁻, PO₄³⁻, or CO₃²⁻. In some embodiments, the multivalent anion is SO₄²⁻.

In some embodiments, the anion exchange membrane has a membrane thickness from about 1 μm to about 100 μm. In some embodiments, the membrane thickness is from about 5 μm to about 60 μm. In some embodiments, the membrane thickness is from about 10 μm to about 20 μm. In some embodiments, the lithium salt solution comprises a total dissolved solid concentration from about 0.5% to about 75%. In some embodiments, the total dissolved solid concentration is from about 1% to about 70%. In some embodiments, the total dissolved solid concentration is from about 10% to about 60%. In some embodiments, the anion exchange membrane comprises a relative transport number of greater than 3 based on the calculation defined by the equation 1. In some embodiments, the relative transport number is greater than 10. In some embodiments, the relative transport number is greater than 50. In some embodiments, the relative transport number is from about 3 to about 2,000. In some embodiments, the relative transport number is from about 50 to about 1,000. In some embodiments, the relative transport number is from about 120 to about 500.

In still yet another aspect, the present disclosure provides methods of preparing an anion exchange membrane comprising reacting a divinylaryl crosslinker with a vinylarylammoniumchloride form an anion exchange membrane.

In some embodiments, the reaction mixture comprises a single solution containing the divinylaryl crosslinker, the vinylarylchloride, and the tertiary amine. In some embodiments, the reaction mixture further comprises pyrrolidone as additive. In some embodiments, the reaction mixture further comprises a thermal or electromagnetic triggered radical initiator. In some embodiments, the electromagnetic trigger of the electromagnetic triggered radical initiator is UV radiation. In some embodiments, the radical initiator is azobisisobutyronitrile. In some embodiments, the vinylakrylammonium forms a new phase from the reaction mixture when the reaction is complete. In some embodiments, the methods further comprise reacting at a temperature from about 0° C. to about 100° C. In some embodiments, the temperature is from about 20° C. to about 75° C. In some embodiments, the temperature is from about 40° C. to about 60° C. In some embodiments, the temperature is about 50° C.

In some embodiments, the methods comprise reacting for a time period. In some embodiments, the time period is from about 1 hour to about 1 week. In some embodiments, the time period is from about 6 hours to about 5 days. In some embodiments, the time period is from about 2 days to about 3 days.

In some embodiments, the methods further comprise washing the anion exchange membrane with an alcoholic solvent. In some embodiments, the alcoholic solvent is a C1-C6 alcohol. In some embodiments, the methods further comprise washing the anion exchange membrane with water. In some embodiments, the methods comprise allowing the anion exchange membrane to soak an acidic solution. In some embodiments, the acidic solution is from about 0.01 N to about 2 N acidic solution. In some embodiments, the acidic solution is from about 0.1 N to about 0. N acidic solution. In some embodiments, the acidic solution is a hydrochloride solution.

In some embodiments, the methods comprise allowing the anion exchange membrane to soak in a salt solution. In some embodiments, the salt solution is a sodium chloride solution. In some embodiments, the salt solution comprises a concentration of the salt from about 0.1 M to about 3 M salt solution. In some embodiments, the concentration of the salt is from about 0.25 M to about 2 M salt solution. In some embodiments, the concentration of the salt is about 0.5 M salt solution.

In still yet another aspect, the present disclosure provides methods of separating chloride anions from sulfate anions in a lithium salt solution comprising exposing the lithium salt solution to an anion exchange membrane, wherein the anion exchange membrane comprises one or more quaternary ammonium ions in a polyvinyl polymer; and allowing the solution to pass such that sulfate anions are retained on one side of the membrane and chloride anions pass through the membrane.

Accordingly, embodiments of this invention provide a method of making monovalent and multivalent anion selective membrane. Such membrane can be used for electrodialysis (“ED”) operation and applied towards the important Cl⁻—SO₄²⁻ separation in said brine lithium extraction. Two novel methods for making such membrane are described in this disclosure. The one-step method is to prepare the necessary monomer first and finally finished during membrane formation. that is suitable for large scale lined production. The two-step method is to prepare the relevant membrane by functionalizing the formed precursor membrane and is also efficient for large scale manufacturing and produces lower resistivity membranes at comparable and even higher selectivity. In the one-step method displayed in FIG. 1A, the control of the membrane thickness is important. As the alkyl chain length increases, the conductivity of the AEM reduces due to less water content. Water molecules inside the membrane are imperative to facilitate ion (anion here) transport through the membrane. The demands for an acceptably low resistivity, the opposite type charge exclusivity, and to some degree of a monovalent anion selectivity prefer a thin membrane manufacture. The membrane thickness should be much less than 100 μm, preferably less than 50 μm, more preferably less than 40 μm, and most preferably from 20 to 40 μm.

### BRIEF DESCRIPTION OF THE DRAWINGS

So that the manner in which the features, advantages and objects of the invention, as well as others which may become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only example embodiments of the invention and is therefore not to be considered limiting of its scope as the invention may admit to other equally effective embodiments.

FIG. 1A is a schematic diagram of p-vinylbenzyltributylammonium chloride that is pre-synthesized and finally co-polymerized with cross link monomer to form membrane, according to one example embodiment.

FIG. 1B is a schematic diagram of a two-step process including co-polymerization of vinylbenzylchloride (“VBC”) and divinylbenzene (“DVB”) and the subsequent amination (tributylamine, for example) treatment to form the said product, according to one example embodiment.

FIG. 2 is a schematic diagram for an ED experiment to evaluate the monovalent anion selectivity of the said membrane, according to one example embodiment. The A* indicates the AEM for the embodiment of this invention to selectively acquire monovalent anion in the ED compartment formed between membrane 206 and 208 (aka, “receiver compartment”, aka “concentrated compartment”, aka to this case “product compartment”) that is circulated with a reservoir (Rr)

FIG. 3 is a sample graph showing electrodialysis (“ED”) testing results for Cl⁻ and SO₄²⁻ in the receiver reservoir (Rr) that is also the selective extraction from a synthetic lithium brine solution through the said selective AEM (A* in FIG. 2), according to one example embodiment.

FIG. 4 is a sample graph showing transport selectivity of Cl⁻ versus SO₄²⁻ through the said selective AEM (A* in FIG. 2) for a lithium brine solution. The AEM here is manufactured using the one step method displayed in FIG. 1A, according to one example embodiment.

FIG. 5 is a sample graph showing transport selectivity of Cl⁻ versus SO₄²⁻ through the said selective AEM (A* in FIG. 2) for a brine solution test data using a two-step process including co-polymerization of vinylbenzylchloride (“VBC”) and divinylbenzene (“DVB”) and the subsequent amination (tributylamine) treatment, according to one example embodiment.

### DETAILED DESCRIPTION OF THE EMBODIMENTS

The present disclosure describes monovalent selective ion exchange membrane (“IEM”) can be important in lithium separation to separate monovalent cations such as Li⁺, Na⁺, and K⁺ from multivalent cations such as Mg²⁺ and Ca²⁺. Using selective cation exchange membranes (“CEM”) can prevent lithium coprecipitation losses, particularly with Mg²⁺. For anion exchange membrane (“AEM”) such selectivity can be used to separate Cl⁻, Br⁻, and NO₃⁻ from SO₄²⁻ of which SO₄²⁻ is responsible for lithium losses by precipitation such as Li₂SO₄·H₂O or Li₂SO₄·K₂SO₄ during lithium concentration. Originally selective monovalent AEM technology was applied to sea salt harvest for pure NaCl table salt. Recently monovalent selective cation membrane has also been applied to the ground water desalting for irrigation to provide the water with enhanced divalent ion (Mg²⁺ and Ca²⁺) ion content to reduce (or alter) the sodium adsorption ratio (“SAR”) to maintain healthy soil structure.

Accordingly, one embodiment of this disclosure is an AEM with high selectivity between monovalent and multivalent anions. It is well understood that the hydration energy between monovalent and multivalent ions is significantly different. Table 1 lists the hydration energy for several anions. Generally, a high hydration energy ion demands more water molecules surrounded to form a tighter ion-water “sphere” to be stable. When an anion migrates through the AEM the positively charged and immobilized exchange site plays a vital role for selective ion transport particularly the hydrophobicity of the exchange site. The most sensitive modification is therefore to make the positive host site more hydrophobic to retard the multivalent anions with a higher hydration energy such as sulfate. The ion transport model cited here leading to the invention of the said selectivity is based on best-known scientific models.

TABLE 1
Gibbs hydration energy for several anions.

| | Ion | | | | |
|---|---|---|---|---|---|
| | F⁻ | Cl⁻ | NO₃⁻ | I⁻ | SO₄²⁻ |
| Hydration Energy (KJ/mole) | 434 | 317 | 270 | 251 | 1000 |

One embodiment is a method of manufacturing a monovalent anion selective membrane particularly applicable for lithium recovery (separation) from brine. One embodiment is a two-step method utilizing the technology to manufacture ultra-thin membranes. Such thin membranes enable a faster second step quaternization reaction and forms a final membrane product with acceptably low resistance. Another embodiment is a one-step method of preparing the monomer and then polymerization to form final product. The membrane thickness management is also important to control the membrane resistance for ED application particularly for Li brine solution where the TDS are ranged from 5%-45%. The one-step method is also suitable for large scale lined manufacture with a significant economic value.

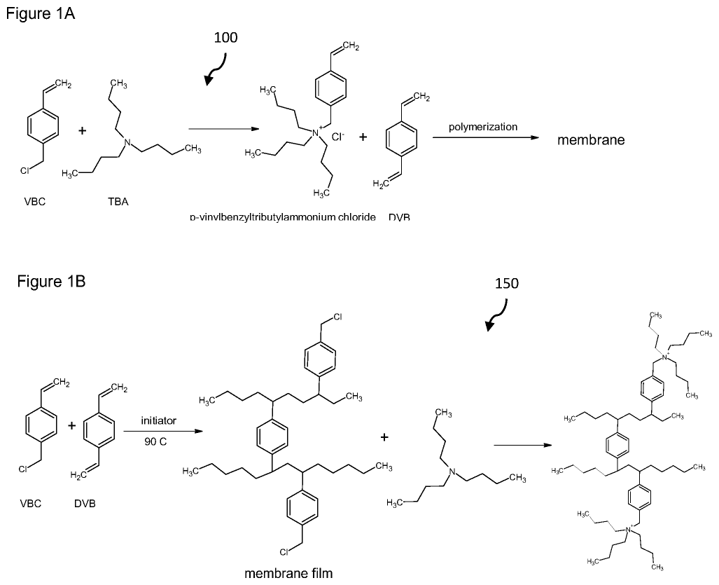

Turning now to the figures, FIG. 1A is a schematic diagram of a one-step process 100 to form monovalent selective AEM by synthesizing precursor monomer p-vinylbenzyltributylammonium chloride monomer, according to one example embodiment. FIG. 1B is a schematic diagram of a two-step process 150 including co-polymerization of vinylbenzylchloride (“VBC”) and divinylbenzene (“DVB”), and the subsequent amination (tributylamine, for example) treatment, according to one example embodiment.

Another embodiment of this invention for one step synthesis using longer chain amine is in addition to alter the hydrophobicity the vinylammonium product is more likely form a phase separation from unreacted reactants or other additives. Since the separation of monomer as for purification purpose is usually difficult, the disclosure of the phase separation provides a method to obtain pure monomer mixture for improved quality AEM manufacture. This phase separation may be applied to a wide range of different amine groups that may be reacted with the monomer to obtain such a membrane as would be apparent to a skilled artisan after reviewing this disclosure.

As shown in FIG. 1B, the two-step process 150 includes co-polymerization of vinylbenzylchloride (“VBC”) and divinylbenzene (“DVB”), and the subsequent amination (tributylamine) treatment. When amine group includes bulky groups such as a long alkane chain, the combination of low reactivity of such amine and the limit of bulk diffusion is detrimental to the membrane production. When preparing monovalent selective AEM using one step method, due to the hydrophobicity of alkane group, the formed membrane has a high resistivity. Besides, the present disclosure provides membranes that are particularly useful for the application of Li brine processing of which the TDS is ranged from 50% to 70% and usually more often from 10% to 40%. The Donnan effect results in the water content in the ion exchange membrane is usually low or resistivity significantly high. Therefore, there is a significant advantage to have a thin membrane both for one step and two step methods. Accordingly, one embodiment is a method of forming a thin membrane with low areal resistivity for water desalting treatment using a one-step method. One embodiment of this invention is to present this method including both chemistry and the membrane formation for lithium-ion extraction from a very high concentration brine solution. This disclosure illustrates the feasibility of the ion exchange membrane for such high salinity applications for monovalent ion selective separation using membrane electrodialysis. The membrane is applied in a brine solution for certain ion extraction with a total dissolved solid (“TDS”) higher than 3.5%, pH between 0-14, or typically 1-13 or even more preferably between 2-11 and a comparable or high ratio for Mg²⁺, Ca²⁺, Na⁺ or K⁺ concentration to Li⁺. Low TDS on the other hand is defined as brine having <3.5% TDS. The concentrations of Li⁺, Mg²⁺ etc. are often referred to a parts per million (“PPM”). The important part of this disclosure is to selectively transport Li⁺ from any other ions with less concern on concentration range relative to other species.

FIGS. 1A and 1B illustrate the one and two step methods 100, 150 to form monovalent selective AEM by using tri-n-butylamine. The one step method 100 shown here includes monomer preparation and then feeding into the membrane lined machine for high throughput continuous production. The two step method 150 forms VBC-DVB copolymer using a continuous membrane manufacturing machine and is then treated with TBA solution to functionalize the benzylchloride groups by quaternization reaction.

### EXPERIMENTAL EXAMPLES

The following experimental examples are meant to illustrate a method of making monovalent and multivalent selective AEM for ED application particularly for hydrometallurgy of lithium.

### Example 1

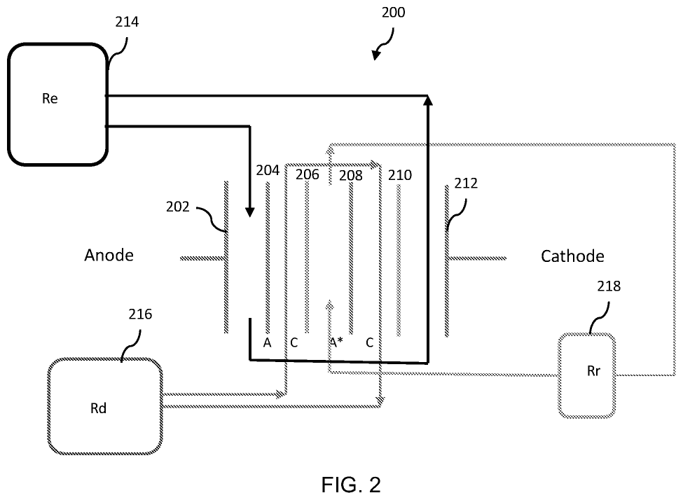

A membrane is tested for its selectivity, Cl⁻ ion versus SO₄²⁻ ion, using the electrodialysis (“ED”) device 200 illustrated in FIG. 2. The ED device contains six (6) interfacial layers and each is displayed in FIG. 2 sequentially from left: an anode plate 202, AEM 204, CEM 206, AEM* 208, CEM 210, and a cathode plate 212. The five compartments of the ED 200 are with the same sequence from left: anolyte, dilute (aka donor, aka dilute) compartment circulated by a peristatic pump from reservoir 216, concentrate (aka receiver, aka concentrate) compartment from reservoir 218, dilute compartment from reservoir 214, and catholyte. The AEM* (A*) 208 is the monovalent selective membrane being tested while all the other three membranes 204, 206, 210 are regular ion exchange membranes. The electrical migration flux area of the cell is approximately 6 cm². A current density of 300 A/m² is applied between the two electrodes and each of the five compartments are circulated by the peristatic pumps shown in FIG. 2. The dilute (donor) stream is 50 g/L Na₂SO₄ and 300 g/L NaCl with a controlled PH=2.5˜3.5. The concentrate compartment connected to the concentrate (receiver) reservoir (Rr) 218 is sampled for Cl⁻ and SO₄²⁻ analysis to study the selectivity. The “A C A* C” is the alternating AEM and CEM forming the donor and receiving stream. The reservoir for receiver (Rr) 218 and/or donor (Rd) 216 is analyzed for ion concentrations by an ion chromatograph (“IC”).

TABLE 2
Synthetic brine solution for Cl⁻ and SO₄²⁻ selectivity test

| | | Concentrate | |
|---|---|---|---|
| | Dilute Reservoir | Reservoir | Electrolyte |
| Volume (liter) | 1.0 | 0.10 | 1.0 |
| NaCl/Cl⁻ content | 300/182 (g/L) | Varied | 0 |
| (g/L) | | | |
| Na₂SO₄/ SO₄²⁻ | 50/33 (g/L) | Varied | 10/6.6 g/L |
| content (g/L) | | | |
| pH | 2.5-3.5 | Varied | 7 |

The permselectivity or the Relative Transport Number (RTN) of Cl⁻ versus SO₄²⁻ is calculated using the following equation by assuming the concentration of the dilute (donor) stream is not affected by the salt ion transported during experiment for all the experiments disclosed herein:

$$RTN = \frac{Δ {C}^{Cl} / Δ {C}^{{SO}_{4}}}{{C}^{Cl} / {C}^{{SO}_{4}}} \qquad Equation 1$$

where ΔC^{C1} and ΔC^{SO4} are respectively concentration different between initial and final in the receiver compartment. Namely amount of Cl⁻ and SO₄²⁻ transported through the membranes into the concentrate stream, and C^{C1} and C^{SO4} are respectively the concentrations of ion Cl⁻ and SO₄²⁻ in the donor (dilute) reservoir which often as constant is the concentration does not change significantly.

Accordingly, one embodiment is an anion exchange membrane suitable for a high TDS operation, combined with cation membrane for metal ion separation from its solution, wherein the metal ion comprises at least one of Li⁺, Na⁺, K⁺, Rb⁺, Zn²⁺, Ca²⁺, Mg²⁺, Sr²⁺, Fe²⁺ and C_{O}²⁺, and wherein the TDS is defined as >3.5%.

### Example 2

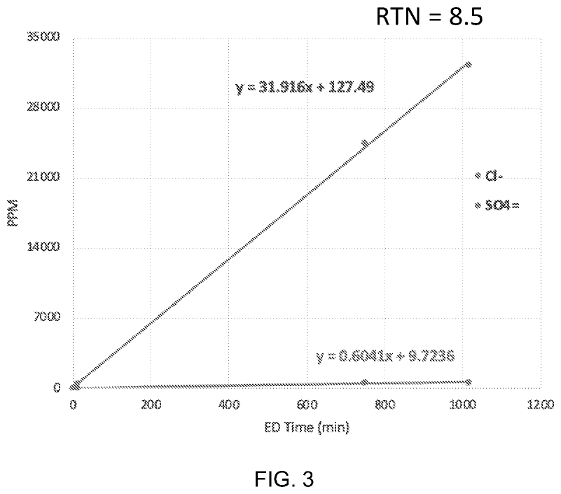

Using the set up in Example 1 and the AEM obtained from the market without the monovalent selective feature, FIG. 3 is the data of the electrodialysis (“ED”) testing results for Cl⁻ and SO₄²⁻ transport from a synthetic lithium brine solution in Table 2 using a membrane without modification to the selectivity, according to one example embodiment. FIG. 3 displays the data from an ED experiment that has a concentration and volume for dilute (donor), concentrate (acceptor) and electrolyte listed in Table 2. The concentration of both Cl⁻ and SO₄²⁻ was analyzed by sampling the concentrate (receiver) reservoir. The elevated selectivity or separation factor compared to low concentration TDS (<3.5%) water separation treatment is more likely enabled by the high concentration brine. Based on the slopes of the two ion transports in FIG. 3, and using Equation 1, the RTN is calculated to be 8.8.

### Example 3

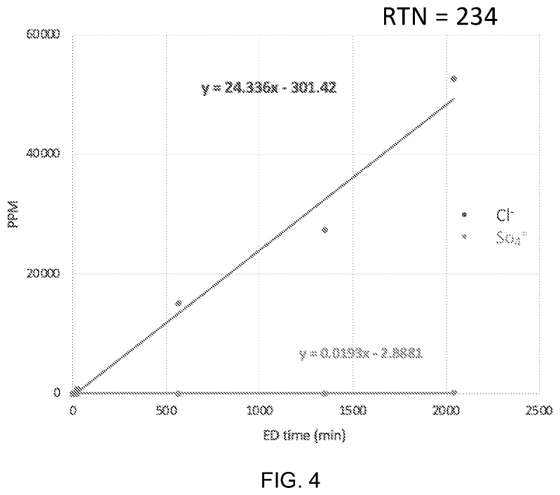

In a glass vial where vinylbenzylchloride (“VBC”), tri-n-butylamine, divinylbenzene (“DVB”), and n-propanol with a mass ratio respectively 10:12:1 is added. The glass via was stirred for 15 hours in a 50° C. environmental chamber. The solution become cloudy and after sitting steady for a few hours, a phase separation occurs. The bottom phase will be separated from the top and adding 2 g NMP and ˜1% of the total solution mass of AIBN. A ˜Porous polyethylene (“PE”) films with a thickness ranged from 24 μm to 42 μm and a porosity of ˜40-55% were soaked in the prepared solution mixture for ˜1-5 minutes. The porous material saturated with the said monomer was sandwiched between two glass plates. Care has been taken to ensure no air bubble is presented between the two glass plates. The sample is baked at 84° C. for 20-50 minutes until fully polymerized. The sample thickness is checked by a micrometer and a thickness of less than ±10% from the original porous film is observed. The 42 μm sample prepared has an areal resistivity ranged from 7-10 Ω-cm² and Donnan potential ˜13.5 mV across the 0.250 M and 0.500 M NaCl solutions. ED test data for Cl⁻ and SO₄²⁻ selective transport is plotted in FIG. 4. Based on Equation 1, the Cl⁻ and SO₄²⁻ RTN for this membrane is ˜234 using calculation method described in Example 2. More specifically, FIG. 4 is a sample graph showing transport of Cl⁻ versus SO₄²⁻ for a lithium brine solution, according to one example embodiment.

### Example 4

The polyethylene (“PE”) film with a thickness 42 μm was soaked in a monomer mixture of vinylbenzylchloride (“VBC”), divinylbenzene (“DVB”), N-Methyl-2-pyrrolidone (“NMP”), and AIBN. The mixture has a ration VBC:DVB:NMP:AIBN=11.0 g:2 g (1.5 g˜2.5 g):2.0 g:0.10 g. The PE film was soaked with the monomer mixture and polymerized into a light-yellow transparent film. The film was then treated with a 25% tri-n-butylamine in methanol solution for 48-72 hours at 50° C. The sample was rinsed with alcohol and water and then soaked in 0.2 N HCl solution for ˜10-30 minutes and soaked in 0.5 M NaCl solution prior to the test.

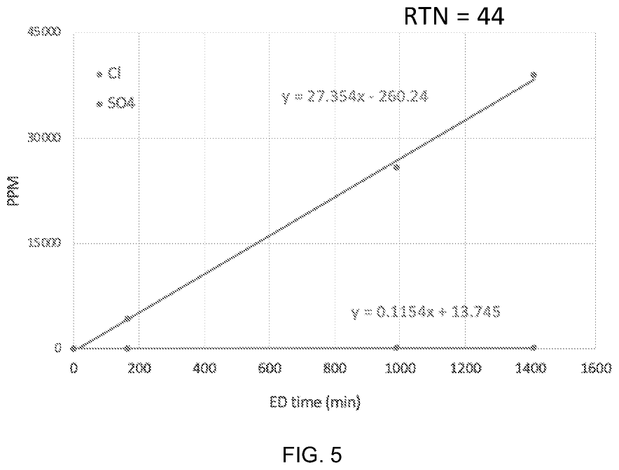

FIG. 5 is a sample graph showing test data using a two-step process including co-polymerization of vinylbenzylchloride (“VBC”) and divinylbenzene (“DVB”) and the subsequent amination (tributylamine) treatment, according to one example embodiment. More specifically, FIG. 5 illustrates transport selectivity of Cl⁻ versus SO₄²⁻ using an AEM prepared with 2-step method illustrated in FIG. 1B. Based on the slopes of the two ion transports in FIG. 5, and using Equation 1, the RTN is calculated to be 44.

The Specification, which includes the Summary, Brief Description of the Drawings and the Detailed Description, and the appended Claims refer to particular features (including process or method steps) of the disclosure. Those of skill in the art understand that the invention includes all possible combinations and uses of the particular features described in the Specification. Those of skill in the art understand that the disclosure is not limited to or by the description of embodiments given in the Specification.

Those of skill in the art also understand that the terminology used for describing the particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced. The verb “operatively connecting” and its conjugated forms means to complete any type of required junction, including electrical, mechanical or fluid, to form a connection between two or more previously non-joined objects. If a first component is operatively connected to a second component, the connection can occur either directly or through a common connector. “Optionally” and its various forms means that the subsequently described event or circumstance may or may not occur. The description includes instances where the event or circumstance occurs and instances where it does not occur.

Conditional language, such as, among others, “can,” “could,” “might,” or “may,” unless specifically stated otherwise, or otherwise understood within the context as used, is generally intended to convey that some implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The systems and methods described herein, therefore, are well adapted to carry out the objects and attain the ends and advantages mentioned, as well as others inherent therein. While example embodiments of the system and method have been given for purposes of disclosure, numerous changes exist in the details of procedures for accomplishing the desired results. These and other similar modifications may readily suggest themselves to those skilled in the art, and are intended to be encompassed within the spirit of the system and method disclosed herein and the scope of the appended claims.

1. A method of separating monovalent anions from one or more multivalent anions in a lithium salt solution comprising:
(A) exposing an anion exchange membrane, wherein the anion exchange membrane is a polymer membrane containing one or more quaternary ammonium cations; and
(B) allowing the anions in the lithium salt solution to pass through the anion exchange membrane such that monovalent anions are on one side of the anion exchange membrane and multivalent anions are on the other side of the anion exchange membrane.

2. The method of claim 1, wherein the quaternary ammonium cation comprises at least two alkyl chains on the nitrogen atom that are not tethered to the polymer chain.

3. The method of claim 2, wherein the alkyl chains are each from about 1 carbon atoms to about 12 carbon atoms.

4.-6. (canceled)

7. The method of claim 1, wherein the anion exchange membrane is crosslinked.

8.-9. (canceled)

10. The method of claim 1, wherein the polymer backbone is a vinylbenzene.

11. The method of claim 1, wherein the anion exchange membrane is prepared by saturating a substrate with the monomer containing thermal or UV initiator and polymerized subsequently.

12.-16. (canceled)

17. The method of claim 1, wherein the monovalent anion is a halide.

18.-19.

20. The method of claim 1, wherein the multivalent anion is SO₄²⁻, PO₄³⁻, or CO₃²⁻.

21. (canceled)

22. The method of claim 1, wherein the anion exchange membrane has a membrane thickness from about 1 m to about 100 m.

23.-24. (canceled)

25. The method of claim 1, wherein the lithium salt solution comprises a total dissolved solid concentration from about 0.5% to about 75%.

26.-27. (canceled)

28. The method of claim 1, wherein the anion exchange membrane comprises a relative transport number of greater than 3 based on the calculation defined by the equation 1.

29.-30. (canceled)

31. The method of claim 28, wherein the relative transport number is from about 3 to about 2,000.

32.-33. (canceled)

34. A method of preparing an anion exchange membrane comprising reacting a divinylaryl crosslinker with a vinylarylammoniumchloride form an anion exchange membrane.

35. The method of claim 34, wherein the reaction mixture comprises a single solution containing the divinylaryl crosslinker, the vinylarylchloride, and the tertiary amine.

36. The method of claim 34, wherein reaction mixture further comprises pyrrolidone as a solvent.

37. The method of claim 34, wherein the reaction mixture further comprises a thermal or electromagnetic triggered radical initiator.

38.-39. (canceled)

40. The method of claim 34, wherein the vinylakrylammonium forms a new phase from the reaction mixture when the reaction is complete.

41. The method of claim 34, wherein the method further comprises reacting at a temperature from about 0° C. to about 100° C.

42.-44. (canceled)

45. The method of claim 34, wherein the method comprises reacting for a time period.

46.-48. (canceled)

49. A method of separating chloride anions from sulfate anions in a lithium salt solution comprising exposing the lithium salt solution to an anion exchange membrane, wherein the anion exchange membrane comprises one or more quaternary ammonium ions in a polyvinyl polymer; and allowing the solution to pass such that sulfate anions are retained on one side of the membrane and chloride anions pass through the membrane.
